(19) United States
(12) Patent Application Publication
(10) Pub. No.: US 2014/0297379 A1
(43) Pub. Date: Oct. 2, 2014

(54) SYSTEM AND METHOD FOR FACILITATING SELECTION OF DATING PARTNERS IN ONLINE DATING ENVIRONMENTS

(71) Applicants: Nikola Bicanic, Venice, CA (US); Arben Kryeziu, Wailuku, HI (US)

(72) Inventors: Nikola Bicanic, Venice, CA (US); Arben Kryeziu, Wailuku, HI (US)

(21) Appl. No.: 13/853,144

(22) Filed: Mar. 29, 2013

(51) Int. Cl. G06Q 30/02; G06Q 50/00

(52) U.S. Cl. CPC G06Q 30/0214; G06Q 50/01
USPC 705/14.16

(57) ABSTRACT

A computer-implemented method for facilitating selection of dating partners in at least one social network including connections among a plurality of users. The method includes a first user browsing through visible user profiles, the first user identifying a second user in the visible user profiles, the first user and second user connected to each other via a third user in the at least one social network and the first user sending an introduction request to the third user for introduction with the second user by paying a first amount of virtual currency from user account associated with the first user. Thereafter, the third user performing one of introducing the first user to the second user to earn a second amount of virtual currency and choosing to keep the introducing request for themselves by paying a third amount of virtual currency.

### TECHNICAL FIELD

The present invention relates to online social networks and, more specifically, to facilitating multiple participants to interact in online environments.

### BACKGROUND

The internet has enabled numerous forms of peer-to-peer communication. For example, online dating where an individual first becomes a subscriber by completing a detailed profile, providing various attributes about himself/herself (e.g. age, weight, location, photos, interests, etc.). The individual may then search for potential matches by filtering other subscriber profiles according to the criteria the individual wishes potential matches to have. However, an individual may intentionally provide inaccurate information about himself in order to appear more attractive to others. For example, individuals may put up fake pictures.

Social networking sites (e.g., Facebook, Google+, MySpace, and others) facilitate social relations in an online environment among people who, for example, share interests, activities, backgrounds, or real-life connections. A social network service consists of a representation of each user (often a profile), his/her social links, and a variety of additional services. Due to real-life connections in the social networks, there is an inbuilt deterrent for users in creating fake profiles and providing wrong information. However, certain types of information cannot be communicated via online profiles. Further, traditional dating requires a fun environment which may be viewed as a game with two players.

In consideration of what is currently being provided by these services and the ever-increasing demand of users for more interesting game like interaction capabilities in the online environments, there is a need for improved user-interactive capabilities and additional technologies for both the social networking and online dating services.

Considering the aforementioned problems, a need exists for a better interactive platform for facilitating interaction and communication between different users, a platform which may substantially increase the users' interest and trust, and the platform's credibility.

### SUMMARY

The present disclosure provides an extremely congenial and effective dating platform for different users to find their desired matches quickly, and fix real dates. Further, the dating platform provides an enjoyable and satisfactory dating experience.

In one aspect, the present disclosure provides a computer-implemented method for facilitating selection of dating partners in at least one social network including connections between a plurality of users. The method includes a first user browsing through visible user profiles. Next, the first user identifying a second user in the visible user profiles, the first user and second user connected to each other via a third user in the at least one social network. Thereafter, the first user sending an introduction request to the third user for an introduction to the second user by paying a first amount of virtual currency from user account associated with the first user. Finally, the third user performing one of introducing the first user to the second user to earn a second amount of virtual currency and choosing to keep the introducing request for themselves by paying a third amount of virtual currency.

In another aspect, the present disclosure provides a computer program product comprising computer executable instructions embodied in a non-transitory computer readable storage medium. The computer program product includes a first computer program code for a first user to browse through visible user profiles in one or more social networks to identify a second user. Next, the first user to send an introduction request to a third user for introduction with the second user by paying a first amount of virtual currency from a user account associated with the first user. The third user to perform one of introducing the first user to the second user to earn a second amount of virtual currency; and choose to keep the introducing request for themselves by paying a third amount of virtual currency. Further, the computer program product includes a second computer program code for receiving the introduction request from the first user, debiting the user account of the first user by the first amount, sending the introduction request to the third user. Further, receiving instruction from the third user to perform one of sending an introduction message from the third user to the second user by crediting the user account of the second user by the second amount and keeping the introduction request with the third user by debiting the user account of the second user by the third amount.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 illustrating an exemplary apparatus for facilitating selection of dating partners in one or more social networks, according to one embodiment of the disclosure.

FIG. 2 is a flow diagram illustrating a method for facilitating meeting new people in one or more online social networks, according to one embodiment of the disclosure.

FIG. 3 to FIG. 9 illustrate the snapshots of the display screens of the electronic communication device of users, as the users interact with each other, according to embodiments of the disclosure.

### DETAILED DESCRIPTION OF ILLUSTRATIVE EMBODIMENTS

In the following description, numerous specific details are set forth to provide a thorough understanding of the present disclosure. However, it will be clear to one skilled in the art that the present disclosure may be practiced without some or all of these specific details. In other instances, well known process steps have not been described in detail in order to avoid unnecessarily obscuring the present disclosure.

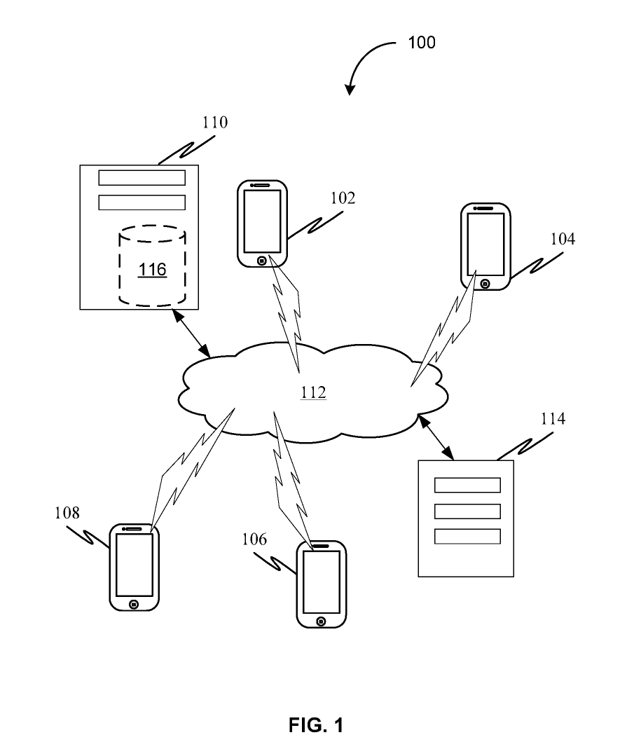

FIG. 1 illustrates an exemplary environment 100 for facilitating selection of dating partners in one or more social networks including connections among a plurality of users. The environment 100 is specifically explained with reference to online dating; however, the current example of a dating environment should not be construed as a limitation to the scope of the present disclosure. Another application of the method may be to meet new professional contacts in an online environment.

The plurality of users using different electronic communication devices 102, 104, 106, and 108 etc., and are logged on to a dating server 110 through a network 112. The electronic communication devices 102, 104, 106, and 108, etc., may be wireless mobile communication devices incorporating touch-sensitive display screens. Further, the devices may be smart communication devices based on a mobile operating system including but not limited to iOS®, Android®, BlackBerry OS®, BlackBerry Tablet OS®, webOS®, Symbian OS®, bada®, Windows Mobile®, Windows Phone OS®, Maemo®, and MeeGo®. Further, the network 112 may be any suitable network such as the Internet. The electronic communication devices connect to the network 112 via one or more of Wi-Fi, Wireless Local Area Network (WLAN), Wireless 3G Network, etc.

The dating server 110 is connected to, and synchronized with a server 114 pertaining to a social networking platform including but not limited to Facebook®, LinkedIn®, Google+®, Ning®, Twitter®, MySpace® Orkut® and flikdate®. The dating server 110 may be connected to more than one social networking platform simultaneously. In an embodiment, the dating server 110 may be a server pertaining to one of the social networking platforms. For example, the server 110 may be a server pertaining to the social networking platform flikdate® which specifically designed for dating environments.

The dating server 110 uses Application Programming Interfaces (APIs) provided by the social networking platforms to connect to, and synchronize with the server 114. As the users log in, the server 110 may retrieve all the publicized details (or predetermined characteristics) of that user using the APIs, and processes those details to prepare a list of visible profiles for each user. The database 116 of the dating server 110 stores information pertaining to the different users registered on the server 110.

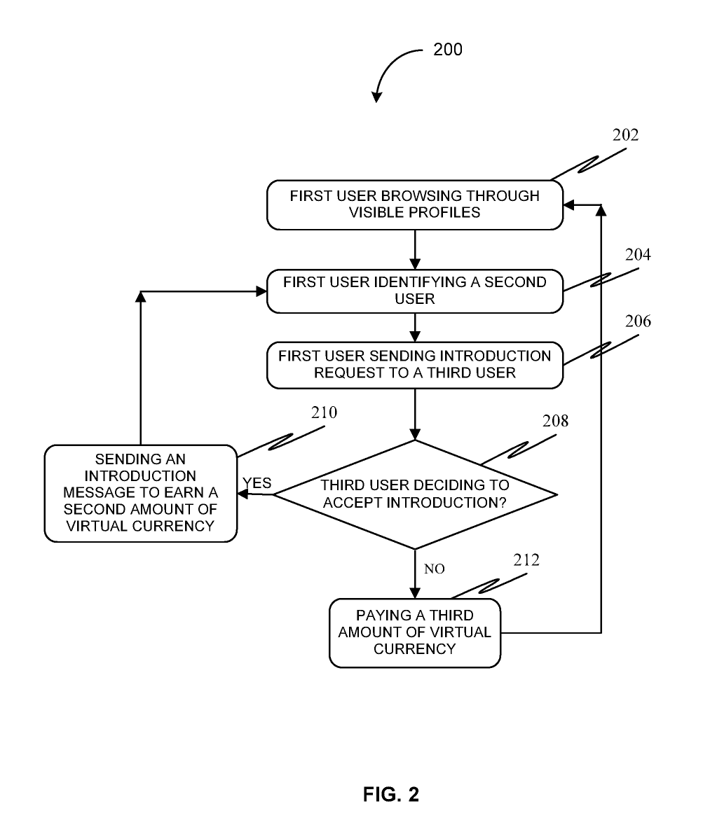

The users may log into the dating server 110 using a Smartphone application installed on the electronic communication devices 102, 104, 106, and 108 etc. The smart phone application renders a user interface on the electronic communication devices, facilitating selection of dating partners in the social networks. The user interface includes user selectable options explained in detail in conjunction with FIGS. 2-9 below. The smart phone application interprets user gestures on the touch screen and facilitates transmission of corresponding messages between the electronic communication devices 102, 104, 106, and 108.

FIG. 2 is a flow diagram illustrating a method 200 for facilitating selection of dating partners in the social networks. The method is specifically explained with reference to online dating; however, this should not be construed as a limitation to the scope of the present disclosure, and the method may find its application in other environments too, where users want to meet new people online.

At step 202, a first user using the electronic communication device 102 to browse through visible user profiles of users in the one or more social networks. The user profiles include one or more of personal details, friends list, photos and videos. A social network includes connections among a plurality of users. The visible user profiles may correspond to profiles of users within a predetermined degree of separation from the first user in the one or more social networks. The minimum number of edges required to connect a user to another user is known as the degree of separation between them. For example, if a user is directly connected to another user (one edge), they are deemed to be separated by one degree of separation. The user would be a so-called “first-degree connection” of the user. Where a user and another user are connected through one other user in between (two edges), they are separated by two-degrees of separation. This user would be a so-called “second-degree connection” of the user. Accordingly, where the player and the user are connected through N edges, they are separated by N degrees of separation. This user would be a so-called “Nth-degree connection.”

The first user browsing through user profiles using one or more predetermined gestures on the electronic communication device 102. The predetermined gestures include a swiping operation performed on the touch-sensitive display screen of the electronic communication device 102, and a clicking or a tapping operation performed over a user selectable option rendered on the display screen of the electronic communication device 102.

Thereafter, at step 204, the first user identifying a second user to connect in the visible user profiles. The first user and second user are connected to each other via a third user in the social networks. In an embodiment, the third user may be the first degree connection of both the first user and the second user. Alternatively, the third user may be separated by two or more degrees of separation from the first user and the second user.

The first user may not be able to directly connect with the second user due to rules of the social networks that restrict communication between users not directly connected to each other. Also, the first user may not want to directly contact the second user as cold messaging/calling is not considerate polite and also the success rate of such activities is very low. Next at step 206, the first user sending an introduction request to the third user requesting for introduction with the second user, by paying a first amount of virtual currency from the virtual currency account associated with the first user. The first user may determine the first amount to be paid for sending the introduction request. flikdate® uses a virtual currency called Further, when required the users may purchase virtual currency by paying real currency to the dating server 110.

On receiving the introduction request, at step 208, the third user decides whether to share the introduction request with the second user or not. If the third user decides to share the introduction request, then at step 210, the third user sends an introduction message to the second user introducing the first user, to earn a second amount of virtual currency in return. However, if at step 208, the third user decides not to share the introduction request, rather choosing to keep the introducing request for themselves, then at step 212, the third user pays a third amount of virtual currency from virtual currency account associated with the third user. The second amount and the third amount may be determined basis the first amount. Alternatively, the first amount, the second amount and the third amount may be predetermined amounts. Further, at step 208, the third user may refuse the introduction request, without paying the third amount. In this case, the first amount paid by the first user or a portion of the same may be credited to his virtual currency account.

The virtual currency indicators are rendered on the display screens of the electronic communication devices of the users, wherein the virtual currency indicators representing remaining amount of virtual currency in virtual currency accounts associated with the users, wherein the virtual currency indicators are continuously updated with time.

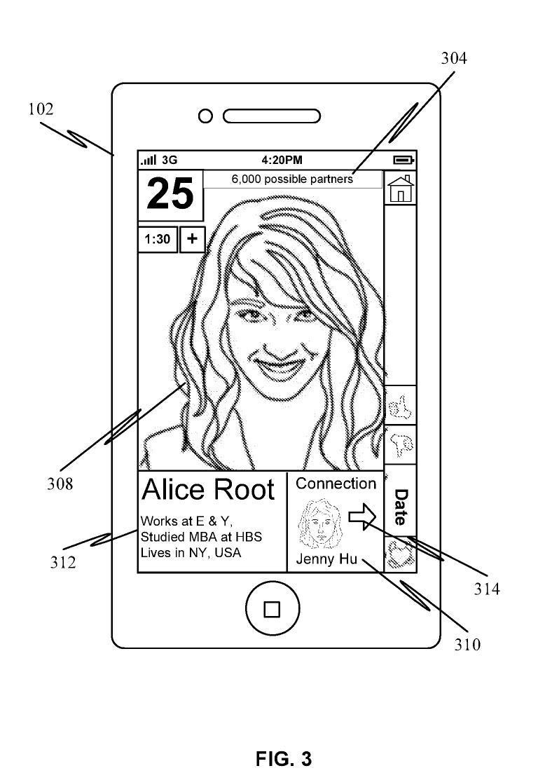

FIG. 3 to FIG. 9 illustrate the snapshots of the electronic communication devices, illustrating various steps involved in introducing the first user to the second user. Further, the FIGS. 3-9 illustrate different features of the dating platform that enhance the users' experiences, as aforementioned.

FIG. 3 is a snapshot of the electronic communication device 102 of the first user “Ben Austin”, as the Ben browses visible user profiles in the one or more social networks, in accordance with an exemplary embodiment. The graphical user interface pertaining to the smart phone application is rendered on a display screen 302 of the electronic communication device 102. Ben may browse through the visible profiles using one or more predetermined gestures such as swiping operation performed on the touch-sensitive display screen of the electronic communication device 102. The number of visible profiles 304 may correspond to the number to user profiles of users within a predetermined degree of separation from Ben in the one or more social networks. For example, the visible profiles may be the profiles of second degree connections of Ben on Facebook. Ben may log on to more social networks using the electronic communication device 102 to increase the number of visible profiles. The number of visible profiles may also depend on the rules of the social networks and the privacy settings selected by individual users registered on the social networks.

As shown in the FIG. 3, while Ben is browsing through the user profiles, he identifies a second user “Alice Root” 308. Alice is connected to Ben via a third user “Jenny Hu” 310. The key information 312 from the user profile of Alice may also be displayed. The key information 212 includes information such as “Works at E & Y, Studied MBA at HBS and Lives in NY, USA”. Ben may like Alice and may want to try to get introduction to Alice through Jenny. For example, Ben may decide get introduction to Alice as he finds her to be hotter than Jenny. So, Ben may click on the arrow 314 to initiate the process to send an introduction request to Jenny.

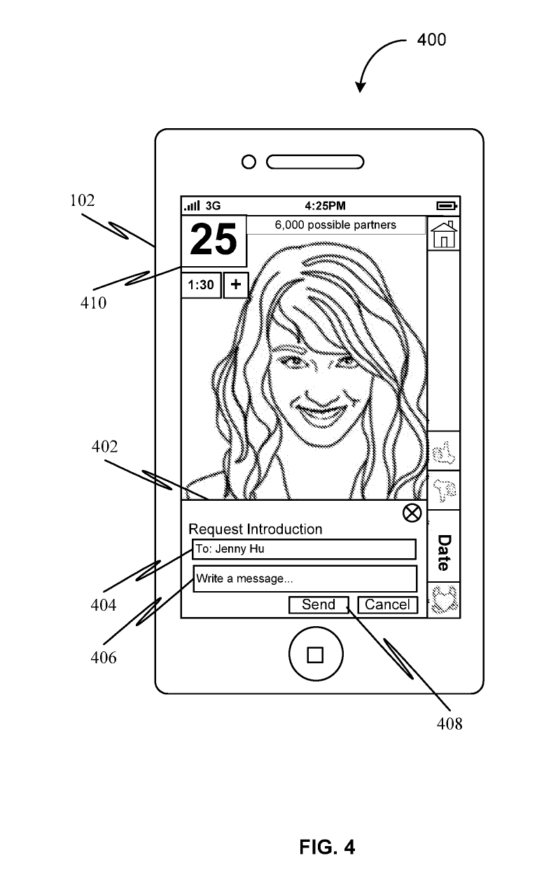

FIG. 4 is a snapshot of the electronic communication device 102 of Ben as Ben sends the introduction request to Jenny, in accordance with an exemplary embodiment. Ben uses a form 402 to prepare the introduction request. A form field 404 displays users who will receive the introduction message from Ben. A form field 406 provides a text field where Ben may write the message he wants to send to Jenny; for example, the message may be “Hey Jenny, I think your friend “Alice” is hot—can you introduce me?” Further, a default message may be displayed that Ben may send to Jenny. Once the message is ready, Ben clicks on a button 408 to send the message to Jenny. In another embodiment, Ben may be able to record an audio and/or video to request introduction from Jenny.

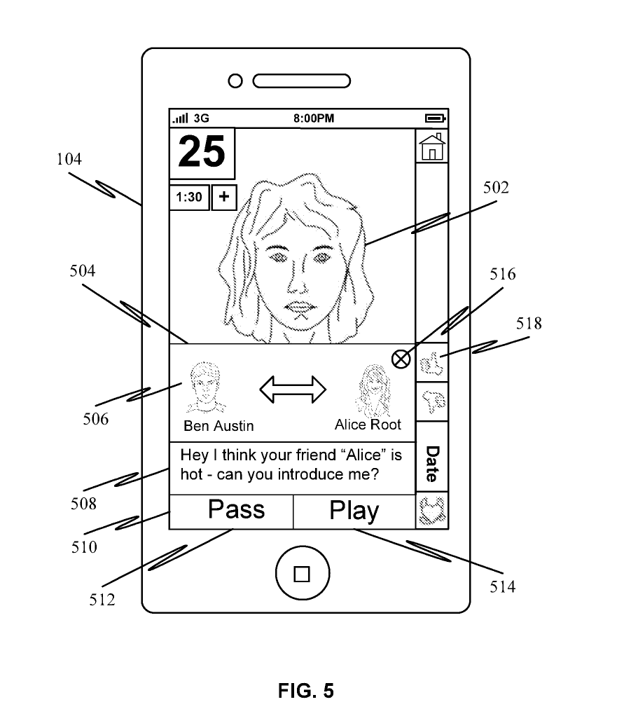

Further, when Ben sends the introduction message a first amount of virtual currency is debited from the virtual currency account of Ben. The first amount may be a predetermined amount. Alternatively, the first amount may be determined by Ben. For example, the default amount may be 5 fliks; however, if Ben thinks Alice is really hot and he really wants to meet her, he may choose to pay higher amounts to increase his chances to get the introduction through Jenny, as Jenny will earnfliks basis the payment made by Ben. This explained in further detail in conjunction with FIG. 5 below. In another embodiment, if Jenny is also online when Ben clicks on the arrow 314, a real time video session may be initiated between Ben and Jenny, where Ben may request introduction and negotiate the price for the introduction. A virtual currency indicator 410 indicates the current amount in the virtual currency account of Ben.

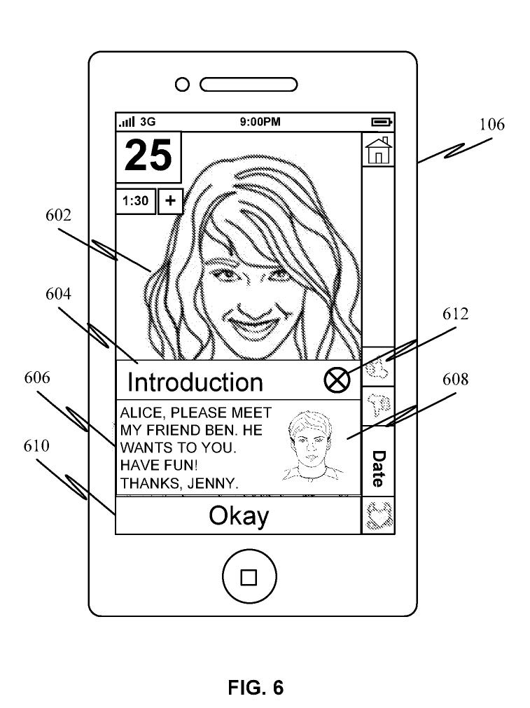

FIG. 5 is a snapshot of an electronic communication device 104 of Jenny 502 as she receives the introduction request from Ben, in accordance with an exemplary embodiment. The notification message 504 displayed on the electronic communication device 104 includes the images 506 of the requesting user “Ben” and the requested user “Alice”. Further, the introduction message 508 sent by Ben is displayed as well. Jenny may decide to introduce Ben to Alice by pressing the Play button 510, to earn a second amount of virtual currency. The second amount may be a predetermined amount or may be determined basis the first amount chosen by Ben. For example, the second amount may be a certain percentage of the first amount such that if Ben pays more Alice gets more. This is explained in further detail in conjunction with FIG. 6 below. Alternatively, Jenny may think Ben is cool and may want to keep him for herself by selecting the ‘Pass’ button 514. In this case, a third amount of virtual currency is debited from virtual currency account of the Jenny. Again, the third amount may be a predetermined amount or may be determined basis the first amount chosen by Ben. Further, Jenny may click on the button 516 to ignore or refuse the introduction request. In this case, the first amount paid by Ben or a portion of the same may be credited to his virtual currency account.

In an embodiment, Ben may get an update about the option chosen by Jenny. In alternate embodiment, Ben may not be informed about the option chosen by Jenny. This creates a game sort of environment, where Ben needs to decide a value high enough to motivate Jenny to introduce him to Alice. Further, Jenny may use a default message or draft a new message to be sent to Alice. In an embodiment, Jenny may earn the second amount or a portion of the same only if Alice accepts the introduction. Therefore, Jenny is motivated to write something more personal or interesting about Ben when she drafts the message for Alice, so that the chances of Alice accepting the introduction increase.

FIG. 6 is a snapshot of the electronic communication device 106 of Alice 602 as she receives the notification 604 about the message from Jenny, in accordance with an exemplary embodiment. The notification 604 includes the message 606 sent by Jenny. The message 604 says, “Alice—Please meet my friend Ben. He wants to meet you. Have fun! Thanks, Jenny”. The notification message 604 may further include Ben's photo 608. Alice may accept the introduction by clicking the ‘Okay’ button 610. Alternatively, she may ignore the introduction by clicking the button 612, in this case Ben may not receive any reply from Alice, so he may be allowed to directly send a connection request to Alice, for example, by clicking the thumbs button 518, which sends a message to Alice that may say ‘He thinks you are hot’.

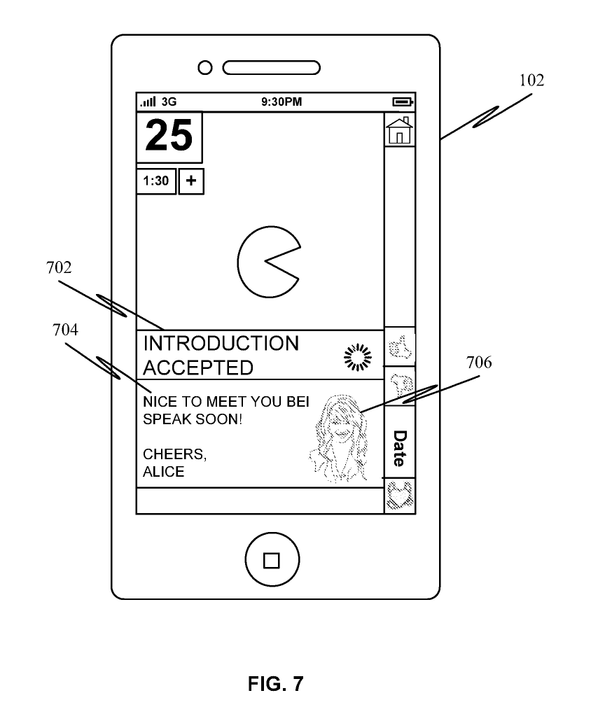

FIG. 7 is a snapshot of the electronic communication device 102 of Ben as he receives the notification message 702 that Alice has accepted the introduction, in accordance with an exemplary embodiment. Further, Alice may send a message 704 to Ben. The message 704 says, “Nice to meet you Ben. Speak soon. Cheers, Alice”. The notification message 702 may also include Alice's image. Further, once Alice accepts the introduction from Ben, both the users are added to each others ‘Datebook’. This is shown in further detail in conjunction with FIG. 7 below. If Ben is online when Alice accepts the introduction, then a real time video session may be initiated between Ben and Alice.

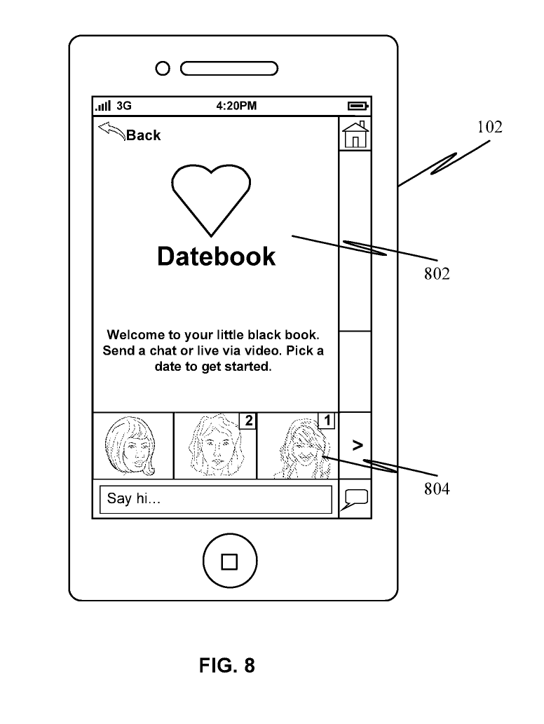

FIG. 8 is a snapshot of an electronic communication device 102 of Ben, showing his datebook 802, in accordance with an exemplary embodiment. The ‘Datebook’ 802 includes list of users; for example, Alice, that have accepted Ben's introduction request. Further, the ‘Datebook’ 802 facilitates a live text chat session 355 or a real time video session between users.

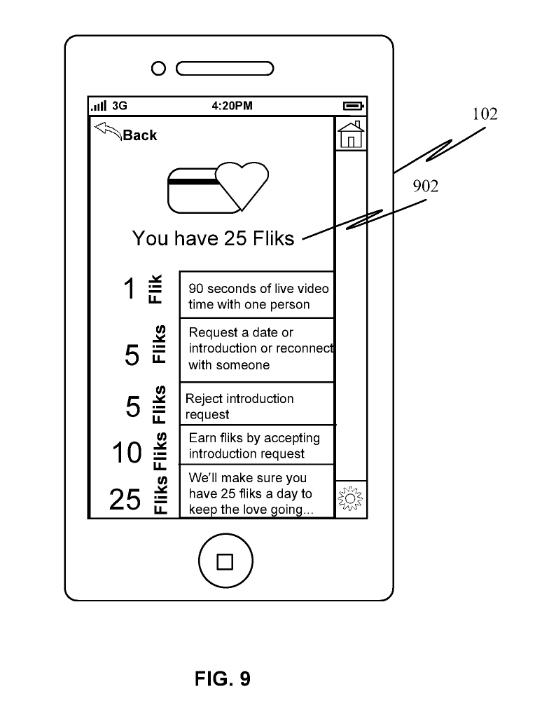

FIG. 9 is a snapshot of the display screen of the device 102, showing a summary of the virtual currency account of Ben. The virtual currency account shows the number of fliks remaining in the user's account 902. Further, the account shows the details of the amount of fliks to be charged for initiating different activities on the dating platform. For instance, as shown, a 90 second of live video chat session costs 1 flik, request for a date costs 5 fliks, rejecting an introduction request costs 5 fliks (default value), accepting an introduction request earns 10 fliks (default value) and the account is credited with 25 fliks in every 24 hours.

Disclosed herein also is a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to a processor, except for a transitory, propagating signal.

The computer program product disclosed herein comprises one or more computer program codes for facilitating selection of dating partners in one or more social networks. For example, the computer program product disclosed herein comprises a first computer program code enabling a first user to browse through visible user profiles in one or more social networks to identify a second user. Thereafter, the first user may send an introduction request to a third user for introduction with the second user by paying a first amount of virtual currency from a user account associated with the first user. Finally, the third user may introduce the first user to the second user to earn a second amount of virtual currency or may choose to keep the introducing request for themselves by paying a third amount of virtual currency. In an embodiment, the first computer code is executed on the electronic communication devices 102, 104, 106, and 108.

Further, the computer program product disclosed herein comprises a second computer program code enabling receiving the introduction request from the first user, debiting the user account of the first user by the first amount, sending the introduction request to the third user. Thereafter, the second computer program code receiving instruction from the third user to perform one of sending an introduction message from the third user to the second user by crediting the user account of the second user by the second amount and keeping the introduction request with the third user by debiting the user account of the second user by the third amount. In an embodiment, the second computer code is executed on the dating server 110 and the server 114.

Although the current invention has been described comprehensively, in considerable details to cover the possible aspects and embodiments, those skilled in the art would recognize that other versions of the invention may also be possible.

What is claimed is:

1. A computer-implemented method for facilitating selection of dating partners in at least one social network including connections among a plurality of users, the method comprising:
a first user browsing through visible user profiles;
the first user identifying a second user in the visible user profiles, the first user and second user connected to each other via a third user in the at least one social network;
the first user sending an introduction request to the third user for introduction with the second user by paying a first amount of virtual currency from user account associated with the first user; and
the third user performing one of:
introducing the first user to the second user to earn a second amount of virtual currency; and
choosing to keep the introducing request for themselves by paying a third amount of virtual currency.

2. The computer-implemented method of claim 1, the user profile includes one or more of personal details, friends list, photos and videos.

3. The computer-implemented method of claim 1, wherein the first user browsing through the visible user profiles of the users within a predetermined degree of separation from the first user in the one or more social networks.

4. The computer-implemented method of claim 1, wherein the third user is the first degree connection of both the first user and the second user.

5. The computer-implemented method of claim 1, the first user determines the first amount to be paid for sending the introduction request, wherein the second amount is determined basis the first amount.

6. The computer-implemented method of claim 1, the third amount is determined basis the first amount.

7. The computer-implemented method of claim 1, the first amount, the second amount and the third amount are predetermined amounts.

8. The computer-implemented method of claim 1, the first user directly sending a connection request to the second user when no response is received for the introduction request to the third user.

9. The computer-implemented method of claim 1, wherein the users using electronic communication devices to log on to the at least one social network, the electronic communication devices are smart communication devices, using a mobile operating system including iOS®, Android®, BlackBerry OS®, BlackBerry Tablet OS®, webOS®, Symbian OS®, bada®, Windows Mobile®, Windows Phone OS®, Maemo®, and MeeGo®, wherein the users login to the at least one social network using an application installed on the electronic communication devices.

10. The computer-implemented method of claim 9, rendering virtual currency indicators on the display screens of the electronic communication devices of the users, wherein the virtual currency indicators representing remaining amount of virtual currency in user accounts associated with the users, wherein the virtual currency indicators are continuously updated with time.

11. A computer-implemented method of claim 9, wherein the application renders the real time video, user profiles, the first and the second virtual currency indicators, the common time indicator and user selectable options on the display screens of the electronic communication devices.

12. The computer-implemented method of claim 1, the first user browsing through user profiles using the one or more predetermined gestures on an electronic communication device, wherein the electronic communication devices incorporate touch-sensitive display screens, and the one or more predetermined gestures include a swiping operation performed on the touch-sensitive display screen of the electronic communication devices, and a clicking or a tapping operation performed over a user selectable option rendered on the display screen of the electronic communication devices.

13. A computer-implemented method of claim 1, the virtual currency may be bought by paying real currency.

14. A computer program product comprising computer executable instructions embodied in a non-transitory computer readable storage medium, wherein said computer program product comprises:
a first computer program code for:
a first user to browse through visible user profiles in one or more social networks to identify a second user;
the first user to send an introduction request to a third user for introduction with the second user by paying a first amount of virtual currency from a user account associated with the first user;
for the third user to perform one of:
introducing the first user to the second user to earn a second amount of virtual currency; and
choosing to keep the introducing request for themselves by paying a third amount of virtual currency; and
a second computer program code for:
receiving the introduction request from the first user, debiting the user account of the first user by the first amount, sending the introduction request to the third user;
receiving instruction from the third user to perform one of: sending an introduction message from the third user to the second user by crediting the user account of the second user by the second amount; and
keeping the introduction request with the third user by debiting the user account of the second user by the third amount.

15. The computer program product of claim 14, further comprising: enabling the first user to browse through the visible user profiles of the users within a predetermined degree of separation from the first user in the one or more social networks.

16. The computer program product of claim 14, the first user determines the first amount to be paid for sending the introduction request, wherein the second amount and the third amount are determined basis the first amount.

17. The computer program product of claim 14, renders user profiles, virtual currency indicators, and user selectable options on the display screens rendering virtual currency indicators on the display screens of electronic communication devices of the users, wherein the virtual currency indicators representing remaining amount of virtual currency in user accounts associated with the users, wherein the virtual currency indicators are continuously updated with time.

18. The computer program product of claim 14, enabling the first user to browse through user profiles using the one or more predetermined gestures on an electronic communication device, wherein the electronic communication devices incorporate touch-sensitive display screens, and the one or more predetermined gestures include a swiping operation performed on the touch-sensitive display screen of the electronic communication devices, and a clicking or a tapping operation performed over a user selectable option rendered on the display screen of the electronic communication devices.

19. The computer program product of claim 14, wherein the users using electronic communication devices to log on to the at least one social network, wherein the first computer program code is executed on the electronic communication devices and the second computer program code is executed on servers associated with the at least one social network, wherein the electronic communication devices are smart communication devices, using a mobile operating system including iOS®, Android®, BlackBerry OS®, BlackBerry Tablet OS®, webOS®, Symbian OS®, bada®, Windows Mobile®, Windows Phone OS®, Maemo®, and MeeGo®, wherein the users login to the at least one social network using an application installed on the electronic communication devices.
